(19) United States
(12) Patent Application Publication
(10) Pub. No.: US 2013/0127673 A1
(43) Pub. Date: May 23, 2013

(54) ELECTRONIC DEVICE WITH MULTI-ANTENNAS

(71) Applicants: SHU-WEI CHANG, Tu-Cheng (TW); HSIN-HUNG LIU, Tu-Cheng (TW); FU-HSIUNG YANG, Tu-Cheng (TW)

(72) Inventors: SHU-WEI CHANG, Tu-Cheng (TW); HSIN-HUNG LIU, Tu-Cheng (TW); FU-HSIUNG YANG, Tu-Cheng (TW)

(73) Assignee: HON HAI PRECISION INDUSTRY CO., LTD., Tu-Cheng (TW)

(21) Appl. No.: 13/329,232

(22) Filed: Dec. 17, 2011

(30) Foreign Application Priority Data
Nov. 17, 2011 (TW) 100141944

(51) Int. Cl. H01Q 1/24

(52) U.S. Cl. 343/702

(57) ABSTRACT

An electronic device includes a first antenna and a second antenna both defined in a housing of the electronic device and respectively connected to a PCB of the electronic device by a component. A slot is defined between the first antenna and the second antenna. The slot forms a capacitor and an inductor to form a filtering circuit for reducing interference between the first antenna and the second antenna.

### BACKGROUND

1. Technical Field

The present disclosure relates to an electronic device with multi-antennas and, particularly, to an electronic device capable of reducing interference between two adjacent antennas.

2. Description of Related Art

Two or more than two antennas are provided in some electronic devices to enable the electronic device to communicate with other electronic devices in different networks. However, if the electronic device includes two or more than two antennas, the two adjacent antennas will interfere with each other.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic view of an electronic device with two antennas in accordance with an exemplary embodiment.

FIG. 2 is a circuit diagram of a filtering circuit for the two antennas of the electronic device of FIG. 1.

FIG. 3 is an interference analysis diagram between a first antenna and a second antenna of the electronic device of FIG. 1 when a slot is not defined between the first antenna and the second antenna.

FIG. 4 is an interference analysis diagram between the first antenna and the second antenna of the electronic device of FIG. 1 when the slot is defined between the first antenna and the second antenna.

### DETAILED DESCRIPTION

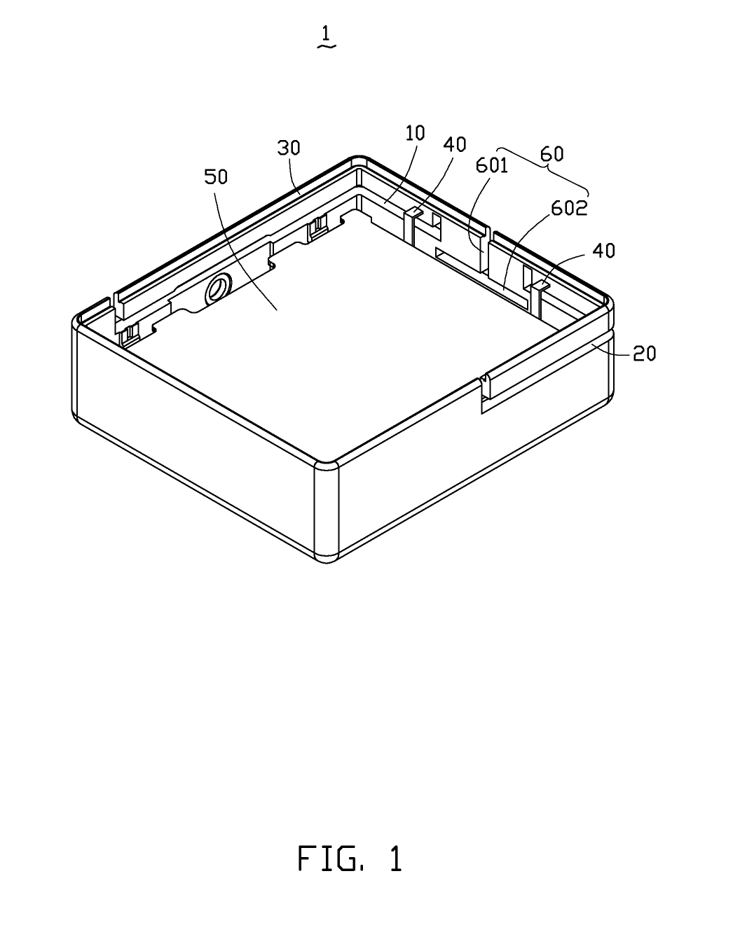

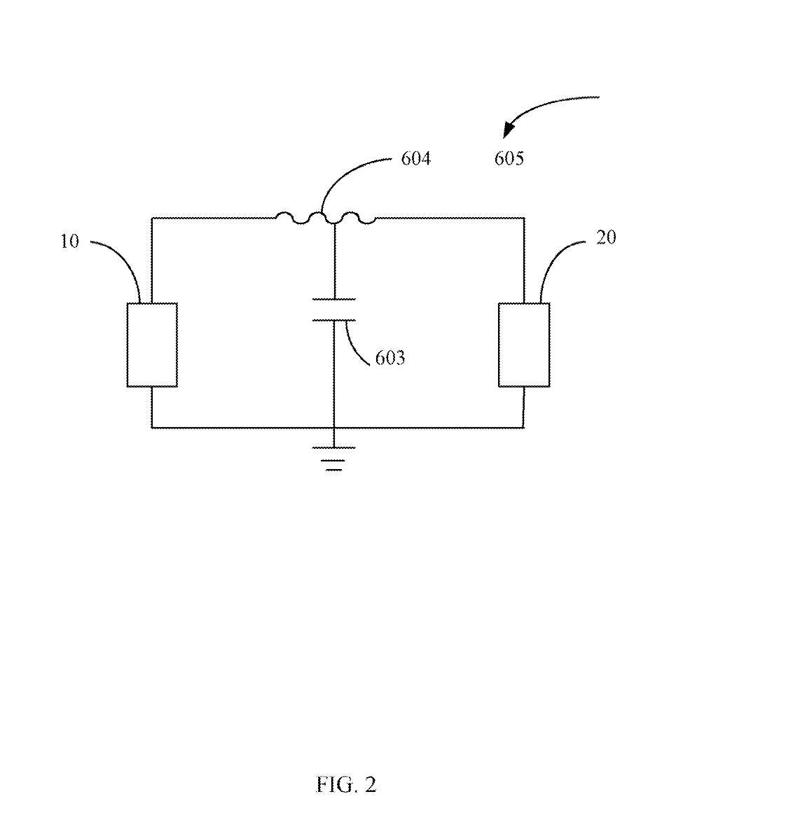

FIG. 1 is a schematic view of an electronic device 1 with two antennas. The electronic device 1 includes a first antenna 10 and a second antenna 20. The first antenna 10 and the second antenna 20 are defined in a housing 30 of the electronic device 1 and are respectively connected to a printed circuit board (PCB) 50 of the electronic device 1 by a component 40. The component 40 is an elastic conductor. In the embodiment, the first antenna 10 and the second antenna 20 are both slot antennas, and the housing 30 of the electronic device 1 is made of metal. Because the first antenna 10 and the second antenna 20 are both set in the housing 30, they have same ground and have strong interference with each other. In order to reduce the interference between the first antenna 10 and the second antenna 20, a slot 60 is defined between the first antenna 10 and the second antenna 20. The slot 60 is substantially reverse T shaped, and includes a vertical slot 601 and a horizontal slot 602. The vertical slot 601 forms a capacitor 603. The horizontal slot 602 forms an inductor 604. The capacitor 603 and the inductor 604 forms a filtering circuit 605, as shown in FIG. 2, for reducing the interference between the first antenna 10 and the second antenna 20.

In the embodiment, the first antenna 10 is a global position system (GPS) antenna whose frequency band is 1.575 GHZ, and the second antenna 20 is a wireless fidelity (WIFI) antenna whose frequency band is 24 GHZ-2.494 GHZ.

In other embodiments, more than two antennas are defined on the housing 30 of the electronic device 1, the slot 60 is defined between two adjacent antenna to reduce interference between the two antennas.

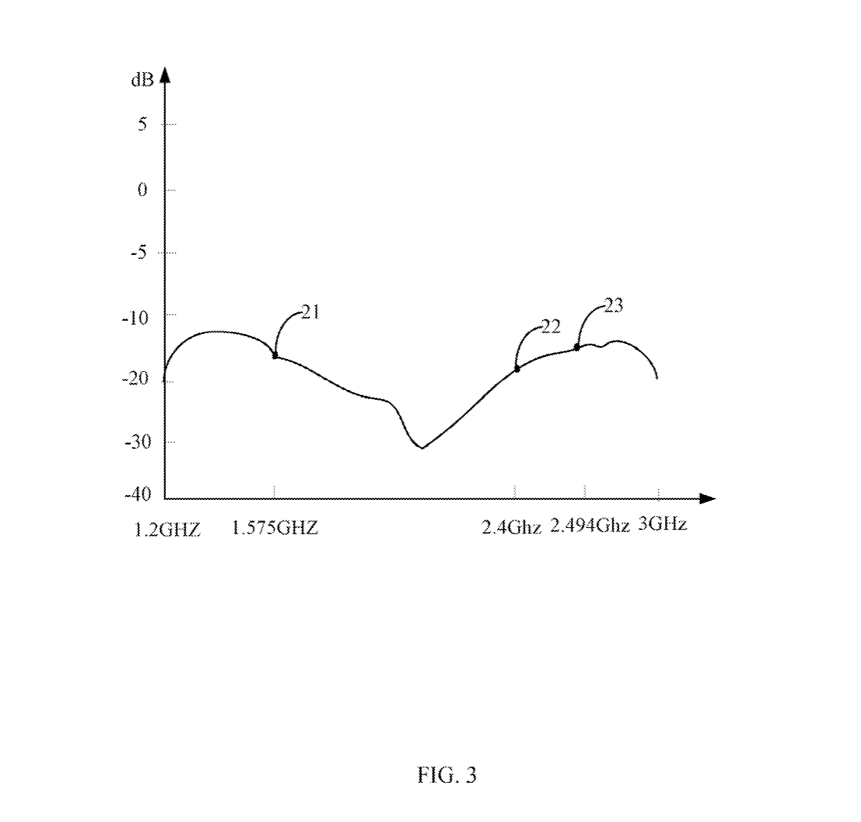

FIG. 3 is an interference analysis diagram between the first antenna 10 and the second antenna 20 when the slot 60 is not defined between the first antenna 10 and the second antenna 20. As shown in the diagram, the isolation of the GPS signal labeled as 21 is −16.985 db, and the isolation of the Wifi signal labeled as 22 and 23 are −17.196 db˜−16.648 db.

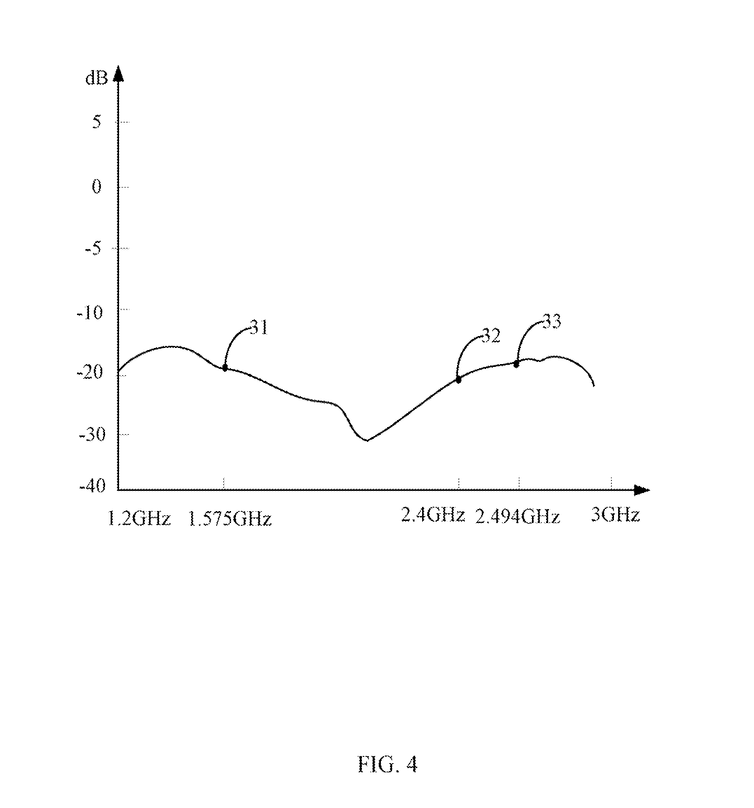

FIG. 4 is an interference analysis diagram between the first antenna 10 and the second antenna 20 when the slot 60 is defined between the first antenna 10 and the second antenna 20. As shown in the diagram, the isolation of the GPS signal labeled as 31 is −19.985 db, and the isolation of the Wifi signal labeled as 32 and 33 are −23.419 db˜−19.854 db. Obviously, when the slot 60 is defined between the first antenna 10 and the second antenna 20, the isolation of the first antenna 10 and the second antenna 20 are both increased, namely the interference between the first antenna 10 and the second antenna 20 is reduced.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device comprising:
a first antenna and a second antenna both defined in a housing of the electronic device and respectively connected to a printed circuit board (PCB) of the electronic device by a component; and
a slot being defined between the first antenna and the second antenna, wherein the slot forms a capacitor and an inductor to form a filtering circuit for reducing interference between the first antenna and the second antenna.

2. The electronic device as described in claim 1, wherein the slot is substantially reverse T shaped and comprises a vertical slot and a horizontal slot, the vertical slot forms the capacitor, and the horizontal slot forms the inductor.

3. The electronic device as described in claim 1, wherein the first antenna is a global position system (GPS) antenna and the second antenna is a wireless fidelity (WIFI) antenna.

4. The electronic device as described in claim 1, wherein the component is an elastic conductor.

5. The electronic device as described in claim 1, wherein the first antenna and the second antenna are both slot antenna.

6. The electronic device as described in claim 1, wherein the housing of the electronic device is made of a metal.
